(19) United States
(12) Patent Application Publication
(10) Pub. No.: US 2008/0223471 A1
(43) Pub. Date: Sep. 18, 2008

(54) Hose with multiple passages

(76) Inventor: Wen-Li Guo, Chang Hua Hsien (TW)

Correspondence Address: Raymond Sun, Esq.;Law Offices of Raymond Sun, 12420 Woodhall Way, Tustin, CA, 92782, US

(21) Appl. No.: 11/717,488

(22) Filed: Mar. 13, 2007

(51) Int. Cl. F16L 9/19

(52) U.S. Cl. 138/113; 138/115

(57) ABSTRACT

A hose includes a central tube located at a center of the hose and a plurality of ribs are connected between the central tube and an inner periphery of the hose so as to define multiple second passages between the central tube and the inner periphery of the hose. The hose includes a circular cross section and is conveniently connected with existed spray nozzles or sprinklers.

### FIELD OF THE INVENTION

The present invention relates to a hose having a central tube and a plurality of ribs connected between the central tube and an inner periphery of the hose so as to define multiple passages.

### BACKGROUND OF THE INVENTION

A conventional hose includes a single passage through which liquid such as water flows. The conventional hose generally has a circular cross section and most of the devices such as spray nozzles or sprinklers, cooperated with the conventional hose are equipped with a circular connection portion so as to be connected with the conventional hose. However, only one passage cannot meet needs for some devices which require more than one kind of liquid supplied. Besides, the conventional hose is easily deformed and the size of the passage is reduced, thereby causing sudden high pressure at the end of the hose that is connected to a faucet. FIG. 1 shows an improved hose which is a flat hose and includes three passages which are located in parallel with each other. A circular connection end is made so as to be connected to the existed devices such as the spray nozzles or the sprinklers. The circular connection ends need extra manufacturing processes which increase the manufacturing cost. If the improved hose does not have the circular connection end as shown in FIG. 2, the devices have to have a special connection end to be connected with the hose. These special connection ends can only be connected with the hoses that have the same number of passages.

The present invention intends to provide a hose which has a circular cross section which is the same as the conventional hose and have multiple passages.

### SUMMARY OF THE INVENTION

The present invention relates to a hose that comprises a central tube located at a center of the hose and a first passage is defined through the central tube. A plurality of ribs are connected between the central tube and an inner periphery of the hose so as to define multiple second passages between the central tube and the inner periphery of the hose.

The present invention will become more obvious from the following description when taken in connection with the accompanying drawings which show, for purposes of illustration only, a preferred embodiment in accordance with the present invention.

### BRIEF DESCRIPTION OF TIE DRAWINGS

FIG. 1 shows a conventional hose with multiple passages;

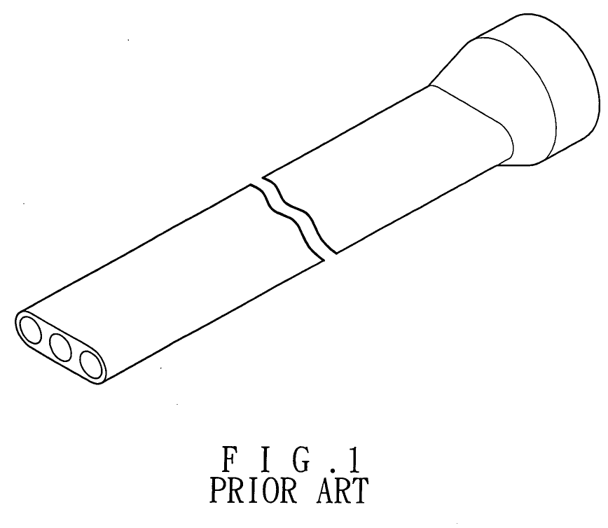

FIG. 2 shows another conventional hose with multiple passages and two devices with special connection ends;

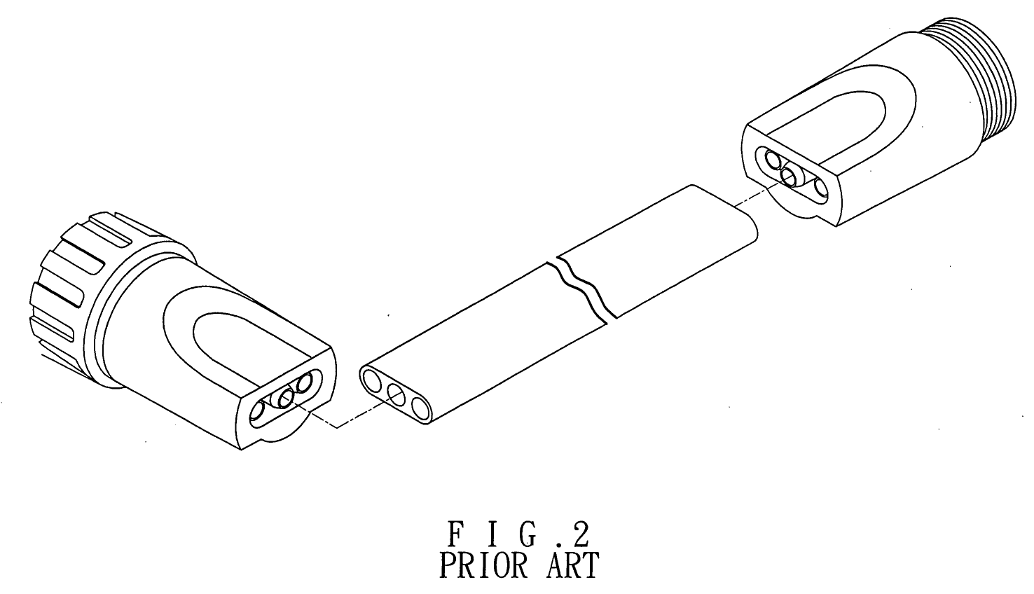

FIG. 3 is a perspective view to show the hose of the present invention, and

FIG. 4 shows that the hose of the present invention is connected with a spray nozzle.

### DETAILED DESCRIPTION OF THE PREFERRED EMBODIMENT

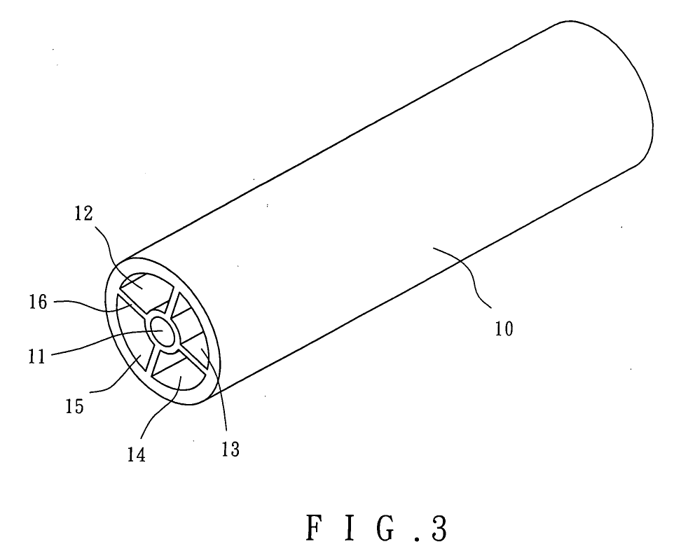

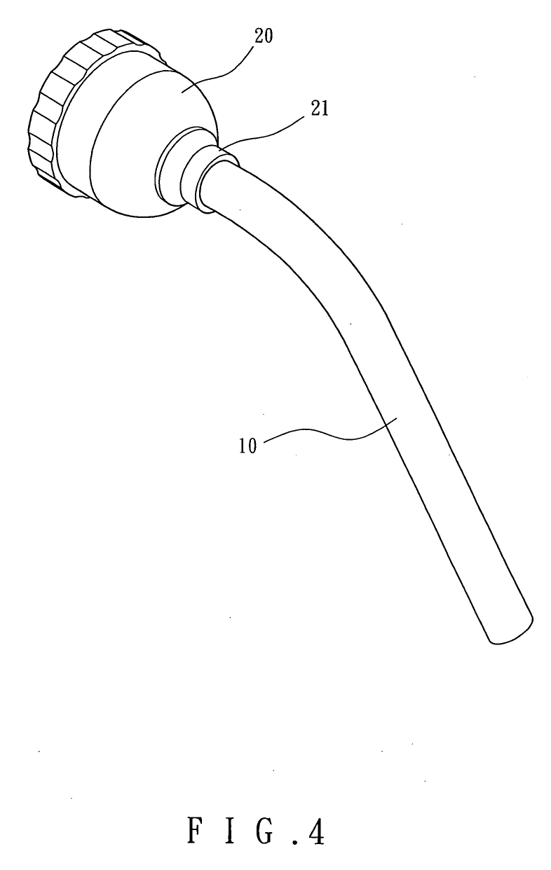

Referring to FIGS. 3 and 4, the hose 10 of the present invention comprises a central tube located at a center of the hose 10 and a first passage 11 defined through the central tube. A plurality of ribs 16 are connected between the central tube 11 and an inner periphery of the hose 10 so as to define multiple second passages 12 to 15 between the central tube and the inner periphery of the hose 10. The hose 10 has a circular cross section so as to be conveniently connected with the connection end 21 of the spray nozzle 20 as shown in FIG. 4.

The hose 10 can be made by known material such as rubber, plastic or metal. The number of the second passages can be varied by different number of the ribs 16. The shapes of the second passages 12 to 15 may also be desired shapes.

The ribs 16 reinforce the structural strength of the hose 10 such that the hose 10 is not deformed easily and the first and second passages 11 to 15 are separated from each other so that different kinds of liquid can be transferred through the first and second passages 11 to 15. A proper device (not shown) can also be connected with the hose 10 to control the transfer of the liquids in different passages.

While we have shown and described the embodiment in accordance with the present invention, it should be clear to those skilled in the art that further embodiments may be made without departing from the scope of the present invention.

1-2. (canceled)

3. An assembly, comprising:
a garden device having a liquid faucet; and
a hose having an end connected to the faucet, the hose comprising:
a central tube located at a center of the hose and a first passage defined through the central tube; and
a plurality of ribs connected between the central tube and an inner periphery of the hose so as to define multiple second passages between the second tube and the inner periphery of the hose.

4. The assembly of claim 3, wherein the hose has a circular cross-section.

5. The assembly of claim 3, wherein the hose is made of rubber.
